(19) United States
(12) Patent Application Publication
(10) Pub. No.: US 2022/0318779 A1
(43) Pub. Date: Oct. 6, 2022

(54) Secure Off-Line Transactions Through Broadcast Encryption

(71) Applicant: International Business Machines Corporation, Armonk, NY (US)

(72) Inventors: Luis Angel Bathen, Placentia, CA (US); Eric Kevin Butler, San Jose, CA (US); Marc Henri Coq, Hopewell Junction, NY (US); Cedric D. Cook, Richmond, TX (US); Akil Khamisi Sutton, Poughkeepsie, NY (US)

(21) Appl. No.: 17/220,436

(22) Filed: Apr. 1, 2021

(51) Int. Cl. G06Q 20/22; G06Q 20/38; H04W 72/00; H04L 9/06

(52) U.S. Cl. CPC G06Q 20/223; G06Q 20/38215; H04W 72/005; H04L 9/0643; G06Q 2220/00

(57) ABSTRACT

Techniques for securing peer-to-peer off-line transactions such as mobile device energy sharing through the use of broadcast encryption are provided. In one aspect, a method for securing transactions includes: encrypting the transactions in a digital wallet of a user in a digital network (e.g., a blockchain network) in a manner whereby the user can encrypt but cannot decrypt the transactions, and other users in the digital network can decrypt but cannot encrypt the transactions, thereby requiring the user to reveal all or none of the transactions in the digital wallet of the user since the user does not know which of the transactions is which, wherein one or more of the transactions are conducted off-line without users having a connection to the digital network.

### FIELD OF THE INVENTION

The present invention relates to peer-to-peer off-line transactions such as peer-to-peer mobile device energy sharing, and more particularly, to techniques for securing these off-line transactions through the use of broadcast encryption.

### BACKGROUND OF THE INVENTION

A blockchain is a type of computing architecture spanning a network of independent machines (or nodes) that enables a distributed peer-to-peer (shared and replicated) database or ledger that is not controlled by a single organization or entity. This configuration permits the nodes to reliably track and maintain the state of information in a system. Thus, advantageously, a blockchain provides a cost-efficient means for creating a business network without requiring a central point of control. By contrast, in traditional database-oriented systems independent parties maintain their own records and reconcile updates with one another in inefficient and sometimes complex inter-organizational processes, which require the services of an independent, trusted third-party administrator.

A blockchain network can be used to track virtually anything of value. One implementation has been in the creation of a smart energy grid. For instance, the electricity produced from renewable energy sources is matched to the electricity consumed by end-users that have a preference for clean energy using blockchain technology. See, for example, U.S. Patent Application Publication Number 2019/0164236 by Mayne et al., entitled “Method of Matching Renewable Energy Production to End-User Consumption Via Blockchain Systems.”

Further, blockchain technology greatly facilitates the generation and sharing of these renewable energy sources in a distributed manner via peer-to-peer (or P2P) energy trading. See, for example, Seven et al., “Peer-to-Peer Energy Trading in Virtual Power Plant Based on Blockchain Smart Contracts,” IEEE Access, vol. 8, 175713-175726 (September 2020).

However, the use of blockchain technology to track peer-to-peer transactions such as energy trading can present some notable challenges. For instance, some peer-to-peer interactions might involve users transacting off-line, which introduces a time delay between when the transaction occurs and when it is broadcast to the blockchain ledger. This can result in undesirable actions such as double spending where the same coin is spent for different transactions but goes unnoticed due to the timing delay.

Therefore, improved techniques for securing off-line transactions would be desirable.

### SUMMARY OF THE INVENTION

The present invention provides techniques for securing peer-to-peer off-line transactions such as mobile device energy sharing through the use of broadcast encryption. In one aspect of the invention, a method for securing transactions is provided. The method includes: encrypting the transactions in a digital wallet of a user in a digital network (e.g., a blockchain network) in a manner whereby the user can encrypt but cannot decrypt the transactions, and other users in the digital network can decrypt but cannot encrypt the transactions, thereby requiring the user to reveal all or none of the transactions in the digital wallet of the user since the user does not know which of the transactions is which, wherein one or more of the transactions are conducted off-line without users having a connection to the digital network.

The transactions of each of the users can be stored locally on devices of the users in a mini-chain in order to permit the devices to agree off-line on a ledger height for verifying the transactions. For instance, when a first user and a second user are transacting off-line, they can agree upon a block K as a starting point based on a height M of a ledger of the first user and a height K of a ledger of the second user, wherein the height M is greater than the height K. The first user will then send his/her last Tk transactions since the block K to the second user which are encrypted, but cannot be decrypted, by the first user. After that, the second user can verify a subsequent transaction Tx1 using the ledger of the second user in conjunction with the last Tk transactions sent by the first user.

The encrypting can be performed using reverse broadcast encryption based on a binary tree with nodes of the binary tree including the users. With reverse broadcast encryption, a self-node corresponding to a Node ID of the user is always revoked to ensure that the user cannot decrypt the transactions. However, full coverage of non-revoked nodes includes the other users such that the other users can decrypt the transactions.

In another aspect of the invention, another method for securing transactions is provided. The method includes: receiving all of the transactions from a digital wallet of a user in a digital network (e.g., a blockchain network) by other users in the digital network, wherein the transactions are encrypted in a manner whereby the user can encrypt but cannot decrypt the transactions, and the other users in the digital network can decrypt but cannot encrypt the transactions, thereby requiring the user to reveal all or none of the transactions in the digital wallet of the user since the user does not know which of the transactions is which; and decrypting, by the other users, the transactions, wherein one or more of the transactions are conducted off-line without users having a connection to the digital network.

The transactions of each of the users can be stored locally on devices of the users in a mini-chain in order to permit the devices to agree off-line on a ledger height for verifying the transactions. For instance, when a first user and a second user are transacting off-line, they can agree upon a block K as a starting point based on a height M of a ledger of the first user and a height K of a ledger of the second user, wherein the height M is greater than the height K. The second user will then receive the last Tk transactions since the block K sent from the first user which can be decrypted, but cannot be encrypted, by the second user. The second user will decrypt and add these last Tk transactions to his/her local cache. That way, when the second user receives a subsequent transaction Tx1 from the first user, the second user can verify that transaction Tx1 using the ledger of the second user in conjunction with the last Tk transactions in the local cache.

The encrypting can be performed using reverse broadcast encryption based on a binary tree with nodes of the binary tree including the users. With reverse broadcast encryption, a self-node corresponding to a Node ID of the other users is always revoked to ensure that the other users cannot encrypt the transactions.

A more complete understanding of the present invention, as well as further features and advantages of the present invention, will be obtained by reference to the following detailed description and drawings.

### BRIEF DESCRIPTION OF THE DRAWINGS

FIG. 1 is a schematic diagram illustrating an exemplary power-for-pay exchange according to an embodiment of the present invention;

FIG. 2 is a diagram illustrating an exemplary blockchain network as a decentralized exchange in the present mobile device energy sharing marketplace according to an embodiment of the present invention;

FIG. 3 is a diagram illustrating an exemplary system for securing off-line transactions using reverse broadcast encryption according to an embodiment of the present invention;

FIG. 4 is a diagram illustrating an exemplary methodology for securing an off-line transaction according to an embodiment of the present invention;

FIG. 5 is a diagram illustrating an exemplary methodology for securing an off-line transaction with guaranteed transparency using reverse broadcast encryption according to an embodiment of the present invention;

FIG. 6 is a diagram illustrating Merkle chaining of a local mini-chain according to an embodiment of the present invention;

FIG. 7 is a diagram illustrating an exemplary binary tree for broadcast encryption according to an embodiment of the present invention;

FIG. 8 is a diagram illustrating an exemplary methodology for encrypting a transaction using reverse broadcast encryption according to an embodiment of the present invention;

FIG. 9 is a diagram illustrating an exemplary methodology for decrypting the transaction using reverse broadcast encryption according to an embodiment of the present invention;

FIG. 10 is a diagram illustrating an exemplary methodology for securing an off-line transaction by a first user employing broadcast encryption according to an embodiment of the present invention;

FIG. 11 is a diagram illustrating an exemplary methodology for securing an off-line transaction by a second user employing broadcast encryption according to an embodiment of the present invention;

FIG. 12 is a diagram illustrating an exemplary apparatus for performing one or more of the methodologies presented herein according to an embodiment of the present invention;

FIG. 13 depicts a cloud computing environment according to an embodiment of the present invention; and

FIG. 14 depicts abstraction model layers according to an embodiment of the present invention.

### DETAILED DESCRIPTION OF PREFERRED EMBODIMENTS

Provided herein are techniques for securing peer-to-peer off-line transactions through the use of broadcast encryption. For instance, according to an exemplary embodiment, the present techniques are employed in the context of a mobile device energy sharing marketplace where users can request battery charges (power transfers) of their mobile devices from other users. The users that provide the charging service (hereinafter ‘power service providers’ or simply ‘providers’) are incentivized by crypto-currency-based payments and can opt-in to the marketplace to offer their charging services.

However, due to the nature of this mobile framework, network access may be sporadic and users may join or leave the network at any time. Thus, it is expected that at least some of these transactions might be conducted off-line, when network service is unavailable. In that case, there is a time delay between when the charging service is provided, i.e., when the users are off-line, and when the transaction is broadcast for payment. In the meantime, users might undesirably spend the same crypto-currency designated for the charging service on another transaction, an action known as ‘double spending.’

Advantageously, the present techniques provide an effective mechanism for guaranteeing that users are transparent about their transactions, including those conducted off-line. Namely, as will be described in detail below, a unique broadcast encryption scheme is employed herein to enforce full-disclosure of all spending transactions by requiring that users transmit all of their transactions since the users are unable to decrypt their own transactions and thus are unable to know which transaction is which.

A detailed description of the present peer-to-peer energy trading framework for mobile devices is now provided. Many commonly used devices such as mobile devices, e.g., smartphones, and Internet of Things (IoT) devices are power hungry. The IoT refers to a system of devices or ‘things’ that can collect, process and transmit data via the Internet.

A variety of options exist for charging devices including mobile and IoT devices on the go. For instance, wireless charging is one option whereby wireless power transfer can occur between a device and a charging pad and/or between two compatible devices where users can charge other devices using their own device via resonant inductive coupling. This wireless charging technology can be employed with any device which is equipped with circuitry that supports wireless charge or power transfer technologies such as via near-field magnetic coupling (NFMC), Radio Frequency (RF) charging, resonant charging technology, ultra sound charging or transfer of electrical charge such as, but not limited to, wireless charging-enabled mobile and IoT devices. Alternatively, portable power banks allow a user to store electrical energy to be used later for charging a device. These portable power banks are now inexpensive and can charge a device in minutes.

The notion of the present peer-to-peer energy trading for mobile devices is whether users can be incentivized to turn their devices and/or portable power banks into commodities by using what they have to deliver energy to other users in a decentralized pay-for-charge ecosystem. By way of example only, all a user has to do is install an App into their devices, sign-up for an account, and start using the pay-for-charge ecosystem. Namely, as provided above, this ecosystem enables its users (i.e., customers) to request battery charges (power transfers) of their mobile devices from other users/providers. Nearby power service providers can then offer their charging services using their mobile devices with the ability to transfer power and/or portable power banks, etc. The power service providers are incentivized by crypto-currency-based payments and, through this marketplace, can negotiate, bid and agree on power-for-pay exchanges with their customers.

Advantageously, users can obtain and convert renewable energy sources into stored power in their devices. For instance, green energy can be ‘mined’ or collected from renewable energy sources by the users via mechanisms such as solar and/or wind power harvesting, thermal energy harvesting (THE), radiant energy harvesting (REH), mechanical energy harvesting (MEH), etc. This green energy can then be utilized in the present power-for-pay exchanges. The traceability of the energy used in these power-for-pay exchanges to a renewable energy source can be certified via blockchain technology.

For instance, according to an exemplary embodiment, the green energy collected from a renewable energy source is stored inside of a smart battery system at the home of a user. This smart battery system would certify that the energy being collected is indeed green. Further, each household can have some energy index ratio, or other daily quota it can potentially generate. Thus, on a daily basis, that household would sign off that it can generate and transfer, e.g., X kilowatts per day (kW/day), of green energy. This amount is recorded in the blockchain ledger.

When a user charges his/her device (e.g., mobile device, portable power bank, etc.) at home via the smart battery system, that device can certify that the energy was obtained from a green source. This can be done in a number of ways. For instance, by way of example only, the smart battery system may have a smart power outlet that can sign to the generation of the energy and charge of the device. Another method of authentication is via global positioning system (GPS). For instance, GPS on the mobile device can be used to indicate that the mobile device was within the vicinity of the home having the smart battery system. By doing so, it can then be determined that some percentage of the green energy generated by the house for that day was used for charging the mobile device. A transaction can be created on the blockchain ledger that would then be backed by the data on the ledger for the house. By whatever method is employed for traceability, once there is a record that says that the device (i.e., mobile device, portable power bank, etc.) was charged using green energy, then that record can be used to prove that the energy is indeed green.

A detailed description of the bidding process for the power-for-pay exchanges between the power service providers and customers is now provided. According to an exemplary embodiment, bidding is performed through the App that the users have installed into their devices (see above). For instance, the App monitors the charge level of the corresponding device. When the charge drops below a certain (e.g., user-predetermined) level, the device submits a request-for-charge to a decentralized exchange such as a blockchain network. The request-for-charge includes an ‘Ask’ which sets the customer's terms for the power-for-pay transaction such as recharging rate along with other relevant information such as the location (GPS coordinates) of the device needing a charge, the device charge level, etc. For instance, to use an illustrative, non-limiting example, User A (a customer) can have a policy in place on her device that when the charge level of the device drops below 10%, then a request-for-charge is made via the decentralized exchange. Say, for example, that this request-for-charge includes an Ask by User A for a recharge rate of $0.15 kilowatts per hour (kW/h) for a battery having an energy capacity of up to 20,000 milliamp hour (mAh) (meaning that the total power stored will be 3.7×20,000=74,000 milliwatt hour (mWh)—assuming that the portable power bank or other charging device outputs 3.7 volts (V)). The device of User A also provides its GPS coordinates and its current charge level, e.g., 5%.

Other users in the marketplace (i.e., User B, User C, User D, etc.) receive the Ask and provide Bids for their charging services. For instance, to use an illustrative, non-limiting example, User B receives the Ask on his mobile device and Bids that he is 10 minutes away from User A, the device he will use for charging (e.g., his mobile device, portable power bank, etc.) is at 100% charge and charges a rate of $0.20 kW/h. User C receives the Ask on her mobile device and Bids that she is 15 minutes away from User A, the device she will use for charging (e.g., her mobile device, portable power bank, etc.) is at 50% charge and charges a rate of $0.10 kW/h. User D receives the Ask on his mobile device and Bids that he is 5 minutes away from User A, the device he will use for charging (e.g., his mobile device, portable power bank, etc.) is at 80% charge and charges a rate of $0.50 kW/h. Power service providers who receive the Ask also have the option not to place a Bid.

For convenience, User A might simply opt for the power service provider in closest proximity who can thus provide a re-charge the fastest. However, User A might take other factors into consideration, such as whether or not the power service provider supplies renewable energy. Further, User A can optionally set forth her preferences (such as the availability of renewable energy) in the profile for her device needing power. That way, the power service providers can be informed prior to making their bids. The bid-price for the recharging services can then be based on those selection parameters, from which User A can make her selection. A discount may be offered for power that is validated as being renewable.

Thus, the Ask and Bid is basically a bidding process whereby a policy is set that a certain amount of charge, e.g., 10,000 mAh, is needed at a rate of at least, e.g., of $0.15 kW/h, so many power service providers (bidders) may have different rates and different means of available power. For example, one power service provider may have wireless charging (see above), which may take longer for recharge than another provider with a universal serial bus (USB) portable power bank.

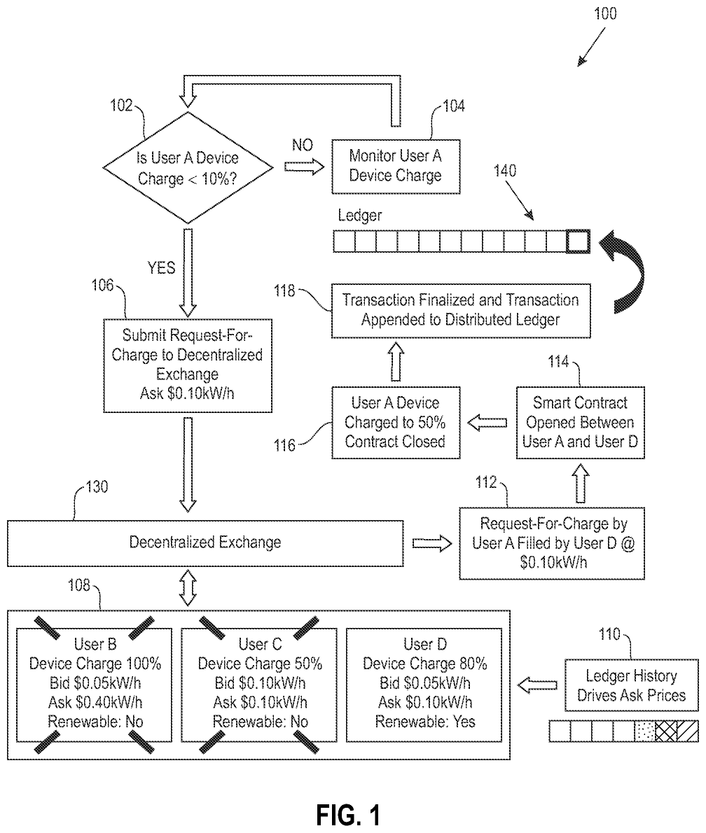

An exemplary implementation of the present bidding process is described by way of reference to methodology 100 of FIG. 1. In this example, the same users are involved in the same roles as above, i.e., User A is a customer with a device needing to be recharged, and Users B, C and D are power service providers bidding for the power-for-pay exchange with User A.

In step 102, a determination is made as to whether the charge in the device of User A is less than a threshold level, in this case 10%. Namely, as provided above, this threshold charge level can be preset by User A. The App can also impose a default threshold charge level that the user can adjust. In either case, when the charge in the device of User A drops below the threshold level, the bidding process is initiated. The user can opt for initiation of the bidding process to occur automatically (i.e., a request-for-charge is submitted whenever charge drops below the threshold) or to be alerted whenever charge drops below the threshold so that the user can initiate the bidding process.

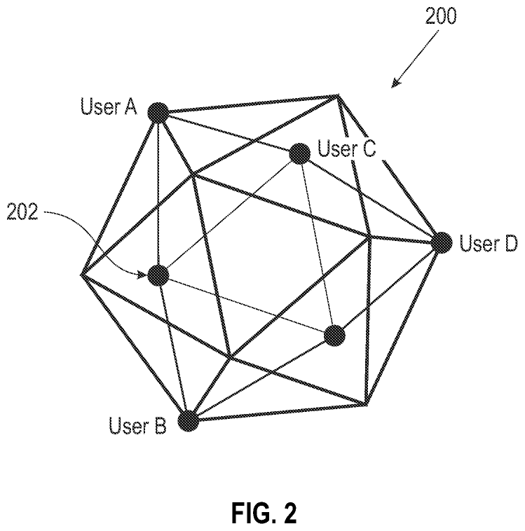

If it is determined in step 102 that NO the charge in the device of User A is not less than the threshold level, then in step 104 the device monitors its charge level until it determines that the charge has dropped below the threshold. On the other hand, if it is determined in step 102 that YES the charge in the device of User A is less than the threshold level, then in step 106 a request-for-charge is submitted to a decentralized exchange 130 such as blockchain network 200 depicted in FIG. 2 and described below.

This request-for-charge includes the Ask from User A which, as detailed above, sets the customer's terms for the power-for-pay transaction such as recharging rate along with other relevant information such as the location (GPS coordinates) of the device needing a charge, the current device charge level, etc. For instance, in the present example, the Ask includes a recharging rate of $0.10 kW/h. As highlighted above, the request-for-charge can be submitted on behalf of User A automatically, i.e., whenever charge drops below the threshold, or by User A when she is alerted that the charge on her device has dropped below the threshold.

Via the decentralized exchange 130, other users in the marketplace (in this example power service providers: User B, User C and User D) receive the Ask and provide Bids for their charging services. As detailed above, these bids can include an estimated time of arrival (ETA), i.e., geographically how far each power service provider is from User A, the amount of charge the device the power service provider will use for the recharging service has and its recharging characteristics based, for example, on the type of device (e.g., portable power bank versus wireless charging device), and recharge rate. A shown in FIG. 1, a differentiation between the source of the energy can also be made, i.e., whether the power service provider will supply renewable/green energy or not. For instance, in the instant example, in step 108 User D will supply renewable/green energy, while User B and User C will not. In step 110, the ledger history is used to determine the Ask price. Namely, the ledger history documents what the user offering charge (i.e., the power service provider) is asking the customer (e.g., User A) to pay for the recharge.

In this particular example, User D can meet the terms of the Ask and has the shortest ETA to User A (see above). Thus, in step 112 the request-for-charge by User A is filled by power service provider User D. To do so, User D meets up with User A and uses his mobile device, portable power bank, etc. to charge User A's device as described in detail above. A smart contract is opened between User A and User D for the charging services. See step 114. In general, a smart contract is an electronic computer program or transaction protocol that is used to document events and actions according to the terms of an agreement, in this case the terms of the power-for-pay exchange between User A and User D.

Once the charging service has been completed, the smart contract between User A and User B is closed. See step 116. It is notable that successful completion of the charging service may result in only a partial charge of User A's device, in this example 50%. For instance, User A may only be able to spare a certain amount of time for the recharging process, and is happy to receive a 50% charge in that time. In that case, the amount of charge received is dictated by the amount of time that the customer (User A) can spare to get some charge. In step 118, the power-for-pay transaction between User A and User B is finalized and appended to the blockchain ledger 140. However, as provided above, due to the mobile nature of users in this framework, network access may be sporadic and users may join or leave the network at any time. Therefore, it is expected that at least some of the charging service transactions that take place between users will be conducted off-line, without network service when access to the blockchain ledger 140 in unavailable. For instance, if User D provides charging services to User A in an area without network access, then there will be time delay after the service has been completed before the transaction is appended to the blockchain ledger 140. As highlighted above, these off-line transactions can present some notable challenges.

In order to understand the pertinent issues, it is helpful to look at the techniques that may be employed to secure on-line transactions for comparison. For instance, on-line transactions can be secured using an escrow service. Namely, when an agreement is reached between the two parties, i.e., power service provider and customer, a deposit of a small amount of coin can be sent to the escrow service by both the power service provider and the customer. In the event that the power service provider does not provide the correct amount of charge to the customer, the escrow service will keep the deposit from the power service provider. Conversely, if the customer does not pay for the power received or does not disclose how much power he/she received, then the escrow service will keep the deposit from the customer.

However, the users bidding for mobile-to-mobile charging (e.g., as per methodology 100 of FIG. 1) can transact off-line. For instance, communication between the devices of the power service provider and the customer can occur even without network access using any type of proximity-based connectivity, such as WiFi®, Near-Field Communication (NFC) and/or Bluetooth® technology. For instance, NFC is often used to exchange digital content, conduct payment transactions, etc. Without network access, however, the above-described escrow service for securing transactions is unreachable. Therefore, local means are needed to secure these off-line transactions.

In the present power-for-pay transactions, the target transaction is a monetary exchange between two parties, the power service provider and the customer. Namely, upon delivery of the requested charge to the customer, the customer needs to transmit the monetary reward to the power service provider for such action. However, undesirable actions such as double spending can occur under this framework when the parties transact off-line. For instance, using the above example as an illustration, when User D completes charging the device of User A, User A then pays User D with X coin. Double spending occurs if User A then goes to another merchant and tries to spend the same X coin. If User D does not have network connection, then the only other party that knows about the transaction is User A. Thus, only User A knows that she spent X coin. At a later time, when User D has a network connection and tries to claim the X coin, User D will discover that someone else has already claimed it (double spend). Advantageously, the present techniques provide a simple and effective way by which User A is required to broadcast to the ledger every transaction she has done and thus be fully transparent.

Several assumptions are made regarding the mobile-to-mobile off-line transactions secured in accordance with the present techniques. First, it is assumed that the users (for example, the customer and the power service provider) do not have network access and thus must transact off-line. However, these users had network access at some previous point in time. That way, a valid blockchain with common nodes can be established. Second, it is also assumed that the digital wallets used for payment (see below) are trustworthy and tamper-proof (e.g., key management of the digital wallets is done without user intervention).

Further, while the present techniques may be described in the context of certain exemplary embodiments involving off-line power-for-pay transactions with mobile-to-mobile charging, it is to be understood that the present techniques are more generally applicable to securing any types of off-line transactions. For instance, by way of example only, any framework having users that leave and join the network, and thus may have to transact off-line is within the scope of the present techniques.

As highlighted above, a goal of the present techniques is to obtain full transparency from every user. To do so, users are made to transmit all transactions in their digital wallets since the last longest chain update. The notion is that, by requiring users to disclose everything, they cannot deceive the system such as in the case of double spending. As will be described in detail below, this full transparency guarantee is enforced using reverse broadcast encryption. With this reverse broadcast encryption scheme, users can encrypt their transactions, but cannot decrypt them. Other users in the network can decrypt these transactions but cannot encrypt them. Thus, under this scheme, a user must transmit all of the transactions in his/her digital wallet for payment, or none at all, since the user does not in fact know which transaction is which. This process effectively eliminates the scenario where a user deceptively transmits only select transactions from his/her digital wallet.

An exemplary decentralized, digital blockchain network 200 is shown illustrated in FIG. 2. As shown in FIG. 2, blockchain network 200 includes a network of independent nodes 202 that enable a distributed peer-to-peer (shared and replicated) database or ledger. Each node 202 represents the device of a user in the present mobile device energy sharing marketplace. For illustrative purposes only, the labels ‘User A,’ ‘User B,’ ‘User C,’ and ‘User D’ from FIG. 1 are used.

The blockchain ledger is distributed across the blockchain network 200, whereby each of the nodes 202 has a copy of the blockchain ledger. Namely, nodes 202 are responsible for storing data generated when a transaction takes place. After finalization, each transaction is added to a block of the blockchain ledger. The blockchain ledger is immutable meaning that only new transactions can be added to the blockchain ledger, and historical transactions already part of the blockchain ledger cannot be changed.

The very first block on a blockchain is called the ‘genesis’ block. Since there are no preceding blocks to the genesis block in the blockchain, the genesis block has a block height of zero. The total height of the blockchain is taken to be the height of the most recent (or highest) block in the chain.

A split in the blockchain network is referred to as a blockchain fork. A blockchain fork is resolved when subsequent blocks are added and one of the forked chains becomes larger/longer than the other(s). The largest chain is always the main chain, and the largest chain wins. Namely, the transactions that make it to the largest chain are final, while the forked transactions are discarded and added to a memory pool or mempool.

Digital wallets allow users to manage their cryptocurrency. When users create a digital wallet, they are provided with a public key and a private key that are associated with their wallet. As their names imply, the public key is shared with other users in order to receive funds, while the private key is kept secret and used only by the corresponding user to spend his/her funds. For instance, if User A wants to send some coin from her digital wallet to User D for the charging service, then User A will initiate the transaction using her private key and User B's public key. As highlighted above, a double spend happens when a user tries to spend the same coin twice. Typically, double spending is solved by checking transactions in the ledger, whereby the first transaction to make it to the longest chain wins. Users can play timed attacks in order to try to double spend the same coin. However, this practice can be avoided using a confirmation mechanism whereby only a transaction that has been approved via the confirmation mechanism is verified into the blockchain. If two double spending transactions are undergoing the confirmation process simultaneously, then the transaction with the highest number of confirmations will be includes in the blockchain, while the other transaction is discarded.

However, transacting off-line presents some unique challenges related to double spending. For instance, using the power-for-pay transaction example from above involving User A and User D, say User A is to send X coins to User D upon completion of the charging service. However, due to a loss in network connectivity, User A and User D may have to transact off-line using, e.g., proximity-based connectivity such as WiFi®, NFC and/or Bluetooth®, or some other mechanism. During that time, User A sends X coins to User D for the charging service and records this first transaction Tx1. While both User A and User D are responsible for transmitting Tx1, neither can transmit the transaction due to the lack of network connectivity.

In the meantime, User A might go to another shop and tries to send the same coin X to another user, e.g., User E, for a different, second transaction Tx2. Assume, however, that this transaction between User A and User E is done on-line (on-chain). In that case, transaction Tx2 will be verified and the check for coin X will pass for transaction Tx2. If K-minutes later User D joins the network and transmits the first transaction Tx1, the transaction validation will fail because coin X has already been spent (on transaction Tx2) and User D is out of luck. Advantageously, the present techniques require full transparency of all transactions thereby ensuring that any attempt at double spending will be revealed, thereby effectively preventing users from undertaking any such deceptive practices.

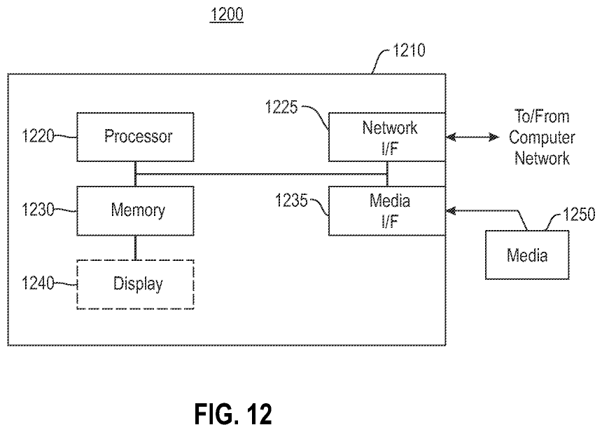

As provided above, while users can communicate and transact off-line, it is assumed herein that the users transacting have had connection to the network sometime in the past. Further, whenever there is network connectivity, each user device will periodically connect with the blockchain network and download ledger updates. See, for example, exemplary system 300 for securing off-line transactions which can be embodied in an apparatus such as apparatus 1200 described in conjunction with the description of FIG. 12, below.

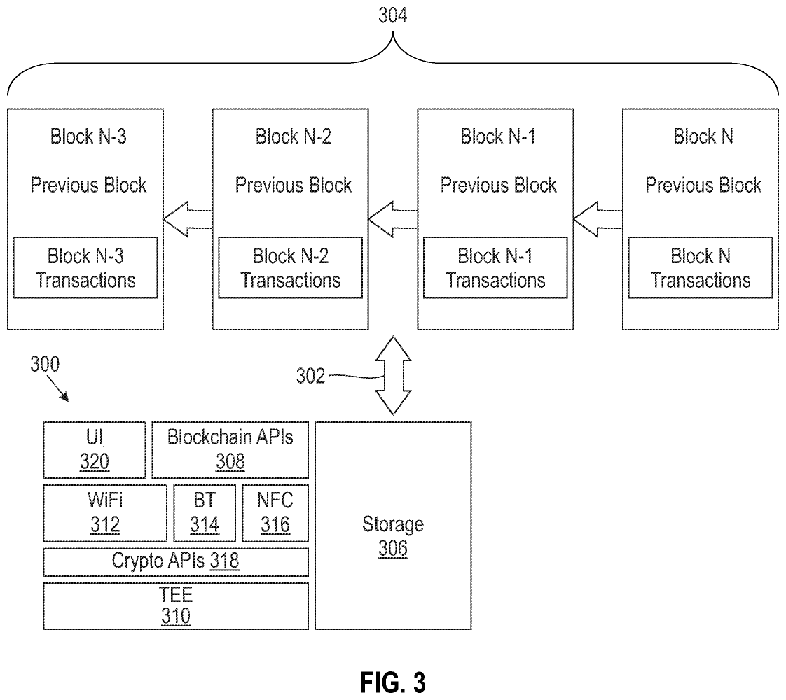

Namely, as shown in FIG. 3, leger updates can be downloaded from the blockchain 304 and stored locally in a storage 306 of system 300 (see arrow 302). Data exchange between the blockchain 304 and system 300 can occur via blockchain APIs 308 or Application Programming Interfaces. As is known in the art, an API is a computing interface that defines interactions between software or hardware/software intermediaries. For instance, blockchain APIs 308 permit software communication between nodes/users such as for the data exchange involved in downloading the ledger updates.

In accordance with the present techniques, the digital wallets used to transact off-line require a trusted executed environment or TEE 310 for secure key management and, naturally, a means for the digital wallets to communicate off-line such as WiFi® 312, Bluetooth® or BT 314 and/or NFC 316. NFC, for example, is often employed to support secure contact-less payment technology. A trusted executed environment is a secure area of a processor that guarantees data loaded therein is protected. A trusted executed environment typically provides an isolated execution environment with security features. Digital wallet (i.e., cryptocurrency or ‘crypto’) APIs 318 provide an interface for users to interact with their digital wallets programmatically (i.e., via a computer program). A user interface or UI 320 enables a user to interact with system 300, including to access the digital wallet to make payments for pay-for-charge transactions.

All transactions are stored locally encrypted in storage 306. As highlighted above, a reverse broadcast encryption scheme is employed whereby users can encrypt their own transactions, but cannot decrypt them. By comparison, other users in the network can decrypt these transactions but cannot encrypt them. As a result, a user must transmit all of the transactions in his/her digital wallet for payment, or none at all, since the user does not in fact know which transaction is which.

As will be described in detail below, every time a new transaction is executed, the users transacting will agree on a block height N, and then exchange all transactions since block height N. Generally, block height refers to a specific location in a blockchain as determined by the number of confirmed blocks in the blockchain that precede that specific location. All of the transactions exchanged between the users are cached (e.g., in storage 306) and kept in a mini-chain.

According to an exemplary embodiment, the mini-chain consists of a Merkle Tree which is a type of data structure that can be used to efficiently and securely encode blockchain data. The Merkle Tree is linked via the Merkle Tree Root of every transaction Tx for each block it belongs to, hashed with the previous block of smaller height. The Merkle Tree Root of a given block is stored in the Hash header. As will be described in detail below, each user device keeps a subset of its transactions stored locally (e.g., in storage 306) and creates a mini-chain of all of its transactions, whereby linking is done via Merkle Trees and Hash headers.

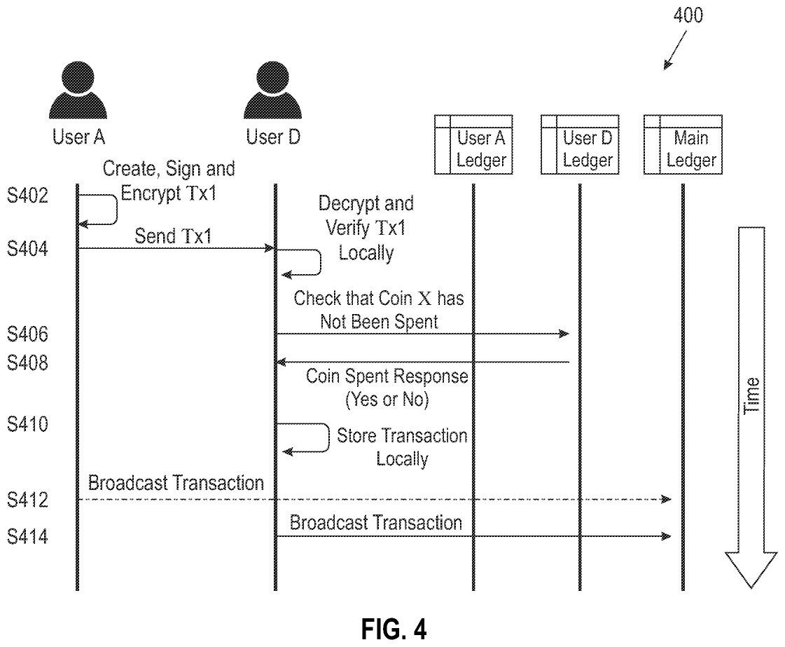

FIG. 4 is a diagram illustrating an exemplary methodology 400 for securing an off-line transaction Tx1. For illustrative purposes only, the same users as above (i.e., User A and User D) are employed in this example, who are engaged in a power-for-pay transaction where User A is the customer and User D is the power service provider. Thus, following completion of the charging service provided by Used D, User A must then send the corresponding X coins to User D using her digital wallet. It is notable that these coins are not stored in the digital wallet. Namely, a digital wallet serves to track a user's funds. The funds (coins) are actually stored in the blockchain in the form of transactions which are created by the digital wallet. Thus, the digital wallet can calculate the user's balance by scanning the transactions within the blocks of the blockchain.

As shown in FIG. 4, in step S402, User A creates, signs and encrypts a transaction Tx1 to pay User D with X coins. In the manner described above, the transaction is created by User A's digital wallet. A digital wallet also signs the transaction on behalf of its owner, in this case User A. A digital signature for the transaction is derived from the transaction details and User A's private key (see above), and can be verified given the transaction details and User A's public key (see above).

In step S404, User A sends transaction Tx1 to User D who decrypts and verifies the transaction Tx1 locally. According to an exemplary embodiment, there is no network connection and User A must send transaction Tx1 to User D off-line, e.g., via proximity-based connectivity such as WiFi®, Near-Field Communication (NFC) and/or Bluetooth® technology (see above). As described above, the users' devices will periodically connect with the blockchain network (when network connectivity is available) and download ledger updates. As will be described in detail below, each user device keeps a subset of all of its transactions with other users stored locally and creates a mini-chain of these transactions. See, e.g., ‘User A Ledger’ and ‘User D Ledger.’ Thus, in step S406, User D can check the transactions stored locally in his User D Ledger to verify that these X coins have not already been spent.

Based on verification from the ledger (stored locally on User D's device) that the X coins have not already been spent (see step S408), User D will store the transaction locally in the ledger on User D's device (see step S410). When connection to the network is restored, both User A and User D will broadcast the transaction Tx1 to the main ledger of the blockchain network (see steps S412 and S414, respectively). Assuming that the transaction occurs without incident, User D will be paid the X coins for providing his recharging services.

However, there are some notable points of vulnerability in this approach. For instance, based on when he last had connection to the network and was able to do a ledger update, User D might not have the most up-to-date record of User A's transactions. If, since the last ledger update, User A had spent the same X coins on another transaction (double spending), then when User D later broadcasts the transaction Tx1 to the main ledger (as per step S414) the transaction validation will fail since the X coins have already been spent. User D will then be out of luck.

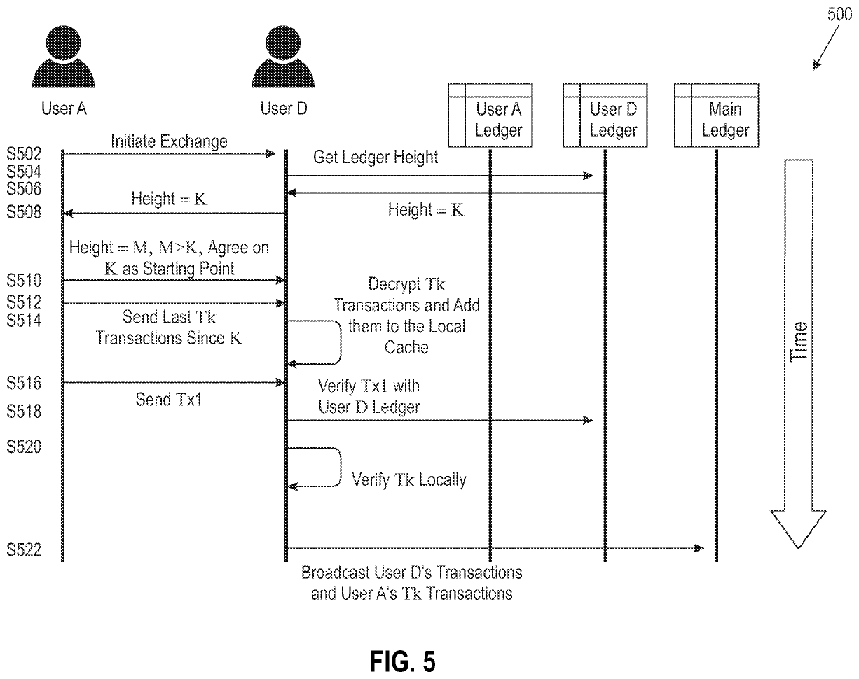

The solution to this problem provided by the present approach is to transact in such a way so as to guarantee full transparency from every user in the network. As highlighted above, this approach involves using reverse broadcast encryption to require users to transmit all of the transactions in their wallets since the last lonest chain update. Doing so makes users to disclose everything so that they cannot get around the system. See, for example, exemplary methodology 500 of FIG. 5 for securing off-line transactions with guaranteed transparency using reverse broadcast encryption. As provided above, reverse broadcast encryption is employed to ensure that whereby users can encrypt their transactions but cannot decrypt them, while other users can decrypt the transactions but cannot encrypt them. That way, users must transmit all or none of the transactions in their digital wallets since they do not know which of the transactions is which.

To ensure transparency, the users that are party to a transaction must first disclose their ledger height. A user's ledger height is basically an indication of when was the last time that user synced up with the main blockchain ledger to download ledger updates. As will be described in detail below, by disclosing their ledger heights the users can establish a common starting point from which point forward all transactions are transmitted. These transmitted transactions in combination with the remaining ledger history (from prior to the agreed upon starting point which both users have in common) provide a complete record of the transactions.

As will be described in detail below, each user device keeps a subset of all of its transactions with other users stored locally and creates a mini-chain of these transactions. See, e.g., ‘User A Ledger’ and ‘User D Ledger.’ Thus, the process begins with User A initiating an exchange with User D (step S502), and User D obtaining a ledger height from the User D Ledger stored locally on User D's device (step S504). According to an exemplary embodiment, there is no network connection and the exchange between User A and User D occurs off-line, e.g., via proximity-based connectivity such as WiFi®, NFC and/or Bluetooth® technology (see above). In this example, User D Ledger returns a ledger height K in step S506.

In step S508, User D reports his ledger height as K to User A. Assume, for example, that the ledger stored locally on User A's device, i.e., ‘User A Ledger’ has a Height=M, where M is greater than K (i.e., M>K). Thus, the User A Ledger and the User D Ledger have different heights, meaning that the last time User A synced up with the main blockchain ledger is different from when User D last synced up with the main blockchain ledger, and that there are differences in their (locally stored) ledger histories. Since M>K, this indicates that User A has synced up with the main blockchain ledger to download ledger updates more recently than User D. Based on this exchange of ledger height data, User A and User D agree on K as a starting point (step S510). This makes sense since the User D Ledger was updated longer ago and thus has a less complete history than the User A Ledger. As such, by selecting K as the starting point, both the User A Ledger and User D Ledger will have the same, complete history of all of User A's transactions (see below).

To use a simple, non-limiting example to illustrate this concept, assume for instance that User D returned a ledger height of 10 (i.e., K=10), and User A returned a ledger height of 7 (i.e., M=7), User D and User A must then agree on using height of 7, which both of them can verify. Then User A would need to disclose all transactions she has generated since Block 7. This will allow User D to see everything User A has done and avoid User D being the subject of a double spend by User A.

Thus, using block K as the agreed upon starting point, in step S512 User A sends the last Tk transactions since block K to User D. Again, it is assumed that this transaction occurs off-line. As described in detail above, in accordance with the present techniques, the transactions are encrypted in a manner whereby users (such as User A) can encrypt but cannot decrypt their own transactions, while other users (including User D) can decrypt but cannot encrypt them. Thus, User A will have to send all of her last Tk transactions to User D in step S512 since User A does not know which transaction is which. User A will encrypt these Tk transactions and, upon receipt, in step S514 User D will decrypt the Tk transactions and add them to his local cache. As provided above, while User D can decrypt the Tk transactions, he cannot encrypt them. This feature prevents User D (and others) from tampering with the transaction data.

Thus, when User A and User D transact, with User A's part of the history from the Tk transactions and the remaining ledger history (from prior to the agreed upon starting point K), User D can verify against a double spend. Namely, in step S516 User A sends a transaction Tx1 (off-line) to User D. In step S518, User D verifies the transaction Tx1 with the User D ledger. As provided above, the User D ledger will provide a history of the transactions from prior to the agreed upon starting point block K. However, User D now also has User A's last Tk transactions stored in User D's local cache.

Thus, in step S520, User D uses these last Tk transactions to also verify the transaction Tk1 locally. Advantageously, use of the transactions in the User D ledger in conjunction with last Tk transactions sent by User A (which, due to reverse broadcast encryption, includes all of User A's transactions since the agreed upon starting point block K) to verify transaction Tx1 provides complete transparency since User D now has a complete history of all of User A's transactions. When connectivity to the digital network is again available, User D will then broadcast to the main ledger all of User D's transactions along with the last Tk transactions of User A (step S522).

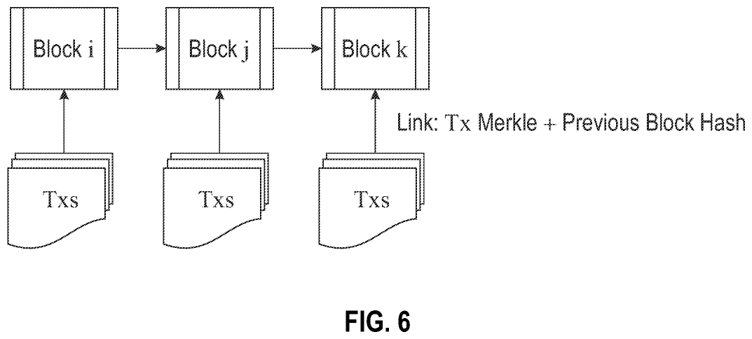

As highlighted above, each user's device keeps a subset of all of that user's transactions with other users stored locally and creates a mini-chain of these transactions. For instance, as described in conjunction with the description of FIG. 5 above, this implementation of a local mini-chain allows the users' devices to agree on a ledger height for transaction verification. According to an exemplary embodiment, linking in the mini-chain is done via Merkle Trees and Hash headers where the users' transactions are maintained. See, for example, the depiction of Merkle chaining in FIG. 6. As shown in FIG. 6, Merkle chaining is employed to combine blocks, i.e., Block i, Block j, Block k, etc. into a larger, hash-verified data structure. The mini-chain is linked via the Merkle Tree Root of every transaction Txs for each block it belongs to, hashed with the previous block. Further, according to an exemplary embodiment, the latest checkpoints from the main ledger are also stored locally. The idea is to establish a local trusted chain that can be used to prove user activity.

As provided above, a reverse broadcast encryption scheme is employed in accordance with the present techniques in order to ensure full transparency of all transactions in that users can encrypt their own transactions, but cannot decrypt them, and other users can decrypt the transactions, but cannot encrypt them. The area of broadcast encryption generally deals with techniques for efficiently broadcasting information to a dynamically changing group of users who are allowed to receive the data. See, for example, Naor D., Naor M., Lotspiech J., “Revocation and Tracing Schemes for Stateless Receivers,” In: Kilian J. (eds) Advances in Cryptology—CRYPTO 2001. Lecture Notes in Computer Science, vol. 2139, Springer, Berlin, Heidelberg (August 2001) (34 pages) (hereinafter also “NNL”). Specifically, the writings of NNL dealt with the problem of a center sending a message to a group of users such that some subset of the users is considered revoked and should not be able to obtain the content of the message. This is analogous to the present scenario where a certain subset of users is revoked and should not be able to decrypt and view the transactions. In the present case, however, it is access by the user who created the transaction that is revoked, hence the use of the term ‘reverse’ broadcast encryption. Namely, according to NNL, a revocation scheme is employed whereby the information is broadcast to a group of users, and revoking access by a subset of users who is excluded from receiving the information. Namely, for each transmission, there is a set of users who should be able to decrypt the data and a set of revoked users who should not be able to do so. See, for example, S. Bhattacherjee et al., “Tree Based Symmetric Key Broadcast Encryption,” Journal of Discrete Algorithms (September 2015) (37 pages) (hereinafter “Bhattacherjee”). By contrast, as will be described in detail below, with reverse broadcast encryption the user who sends the transaction is always revoked, while those that receive the transaction are not.

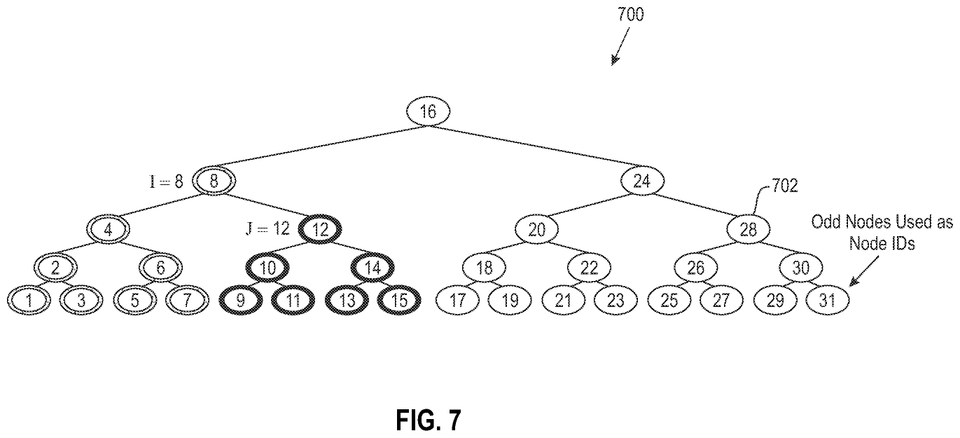

The broadcast encryption scheme described in NNL is based on binary trees, where the users receiving the data/information are the leaves in a rooted full binary tree with a tree height=N (wherein it is assumed N is a power of 2). Only the odd leaves are nodes that are used as Node IDs. See, for example, binary tree 700 shown in FIG. 7. Binary tree 700 includes a plurality of leaves/nodes 702. As shown in FIG. 7, binary tree 700 has a tree height of N=5, wherein 2^{N}=32. In binary tree 700 there are 16 odd nodes, and thus 16 Node IDs.

NNL defined the concept of subset coverage (or Subset-Cover). Namely, given a revocation list consisting of Node IDs, a coverage can be computed where all nodes within a coverage can recover a symmetric key. As described in Bhattacherjee, with symmetric key broadcast encryption, a center (such as a key manager) initially distributes keys to all of the users and also broadcasts the encrypted data in each session. The data to be broadcasted is encrypted with a random session key using a symmetric key encryption algorithm.

Thus, given a set of coverages, full coverage of all non-revoked nodes can be achieved. This is what is referred to herein as the subset coverage. For instance, referring to binary tree 700, the subset covered by I=8, J=12 covers all nodes 702 under 8 but not under 12. The revoked nodes, i.e., nodes 9-15, are outlined in bold. Full coverage is achieved of the non-revoked nodes, i.e., nodes 1-8, outlined in a dotted pattern.

With reverse broadcast encryption, these concepts of Node ID, revocation and coverage are applied to require that users disclose all or nothing with regard to their transactions. Namely, as described above, users cannot decrypt their own transaction data. To do so, users revoke themselves, and thus are unable to decrypt the data (see below where the self-node is always revoked). Other users/nodes in the network can verify this revocation of the self-node. For instance, they can find the Node ID of the node/user that created the transaction. If that node ID is within the coverage and thus not revoked, then the user is not being honest and the transaction can be canceled. Further, as highlighted above, everyone else in the network can decrypt the content broadcasted. Thus, there is security through transparency.

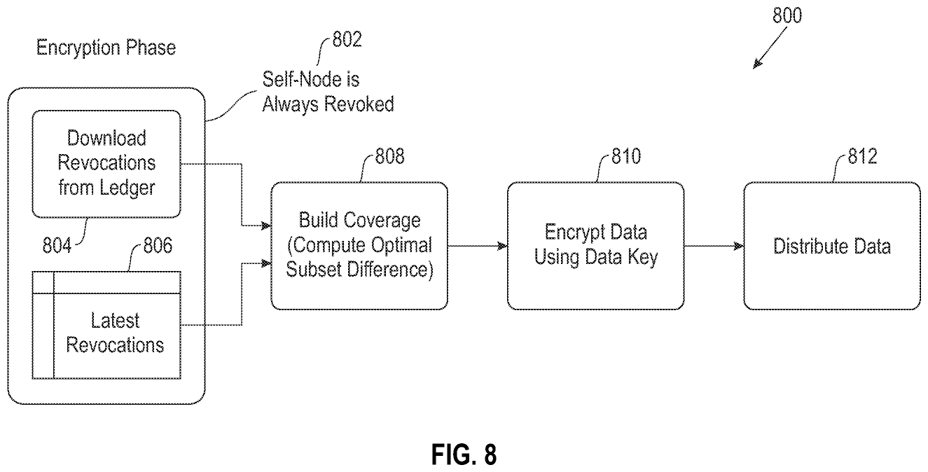

FIG. 8, for example, provides an exemplary methodology 800 for encrypting a transaction using reverse broadcast encryption. Using the above pay-for-charge scenario presented above as an example, methodology 800 may be employed by User A to pay User D via an encrypted transaction by User A's digital wallet after receiving recharging services from User D. Basically, the encryption process as per methodology 800 is performed using reverse broadcast encryption which, as described above, involves a binary tree with the nodes of the binary tree corresponding to the users in the network. Here however, the self-node corresponding to a Node ID of the user is always revoked such that the user creating the transaction (User A in the present example) cannot decrypt the transactions. On the other hand, full coverage of non-revoked nodes (see above) includes all of the other users (including User D in the present example) such that all of the other users can decrypt the transactions.

Namely, in step 802, the self-node (i.e., the node corresponding to the Node ID of the user initiating the transaction, e.g., User A) is revoked. As a result, the user creating the transaction (e.g., User A) cannot decrypt the transactions. As shown in FIG. 8, step 802 involves sub-steps 804 and 806. For instance, in step 804 revocations are downloaded from the ledger which enables the revocation of other users in the network who may no longer need or warrant access to the network, and in step 806 the latest revocations are obtained including self-revocation in order to prevent users from decrypting their own transactions. The notion is that users who cheat, users who no longer need to participate in the network, or users who have deleted their accounts may also be revoked. In order to allow for such a feature, there is a need to keep track of a reference list in the ledger that is to be updated by individuals (who can add themselves), or some trusted participant, who may add parties to the revocation list when needed. Thus, in addition to the self-node, these other users on the revocation list will no longer be able to decrypt the transactions.

In step 808, a coverage of all non-revoked nodes (see above) is built. The goal is to have full coverage of non-revoked nodes that includes all of the other nodes/users (including, e.g., User D) such that all of the other nodes/users can decrypt the transactions encrypted by User A. According to an exemplary embodiment, coverage is built in step 808 by computing an optimal subset difference. A subset difference-based broadcast encryption scheme as proposed by NNL assumes an underlying full binary tree to assign keys to subsets of users. See, for example, S. Bhattacherjee et al., “Reducing Communication Overhead of the Subset Different Scheme,” IEEE Transactions on computers (published October 2015) (33 pages).

For instance, the NNL subset difference-based broadcast encryption scheme uses a one-way triple function to traverse down through the binary tree deriving encryption keys from parent nodes. The one-way triple function is used to determine a processing key as well as left and right children of the node. Thus, the subtree of a given node is accessible. Users are allocated a unique small set of labels (keys) for specific starting nodes, and by applying the triple function, are able to derive any other labels and keys beneath (covered by) those starting nodes. This ability to derive labels from other labels allows for the distribution of a minimal set of keys to a user. Similarly, this process enables the distribution of a minimal set of encryptions. See, for example, U.S. Patent Application Publication Number 2016/0285622 by Geagan, III et al., entitled “Polymorphic Encryption Key Allocation Scheme.”

In step 810 the transaction data is encrypted using a data key, and in step 812 the transaction data and data key are distributed to the users in the network. Since the self-node is revoked, the user creating the transaction (e.g., User A) will not receive the data key and thus will not be able to decrypt the transactions. As highlighted above, if it is found that the node ID of User A is within the coverage and thus not revoked, then the transaction can be canceled.

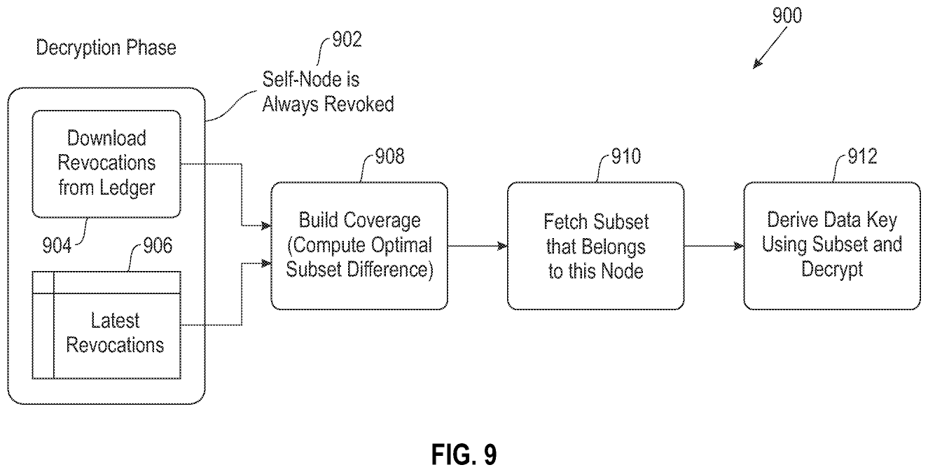

Along those same lines, FIG. 9 provides an exemplary methodology 900 for decrypting the transaction using reverse broadcast encryption. Again, using the above pay-for-charge scenario presented above as an example, methodology 900 may be employed by User D to decrypt the transaction from User A related to payment for the recharging services User A received from User D. As above, the encryption process of methodology 900 is performed using reverse broadcast encryption which, as described above, involves a binary tree with the nodes of the binary tree corresponding to the users in the network. Here however, the self-nodes corresponding to the Node IDs of the other users are always revoked such that the users decrypting the transaction (including User D in the present example) cannot encrypt the transactions.

Namely, in step 902, the self-node (i.e., the node corresponding to the Node IDs of the users decrypting the transaction, e.g., including User D) are revoked. As a result, the users decrypting the transaction (e.g., including User D) cannot encrypt the transaction. As shown in FIG. 9, step 902 involves sub-steps 904 and 906. For instance, in step 904 revocations are downloaded from the ledger which enables the revocation of other users in the network who may no longer need or warrant access to the network, and in step 906 the latest revocations are obtained including self-revocation in order to prevent users from decrypting their own transactions. Namely, as provided above, other users (e.g., those who cheat, no longer need to participate in the network, or who have deleted their accounts) may also be revoked. A reference list of those revoked users is kept in the ledger. Thus, in addition to the self-node, these other users on the revocation list will no longer be able to decrypt the transactions.

In step 908, a coverage of all non-revoked nodes (see above) is built. The goal is to have full coverage of non-revoked nodes (including, e.g., User D) that can decrypt the transaction. According to an exemplary embodiment, coverage is built in step 908 by computing an optimal subset difference which, as described above, assumes an underlying full binary tree to assign keys to subsets of users, and uses a one-way triple function to traverse down through the binary tree deriving encryption keys from parent nodes.

In step 910 the subset of non-revoked nodes (including, e.g., User D) is fetched, and in step 912 the data key is derived and used by the subset of non-revoked nodes (including, e.g., User D) to decrypt the transaction. It is notable that the self-node (e.g., User A) has been revoked, and thus cannot decrypt the transaction.

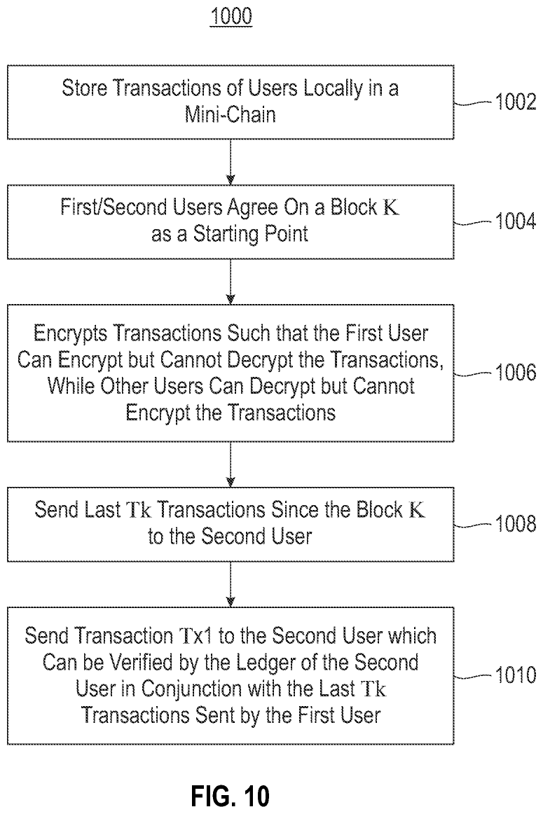

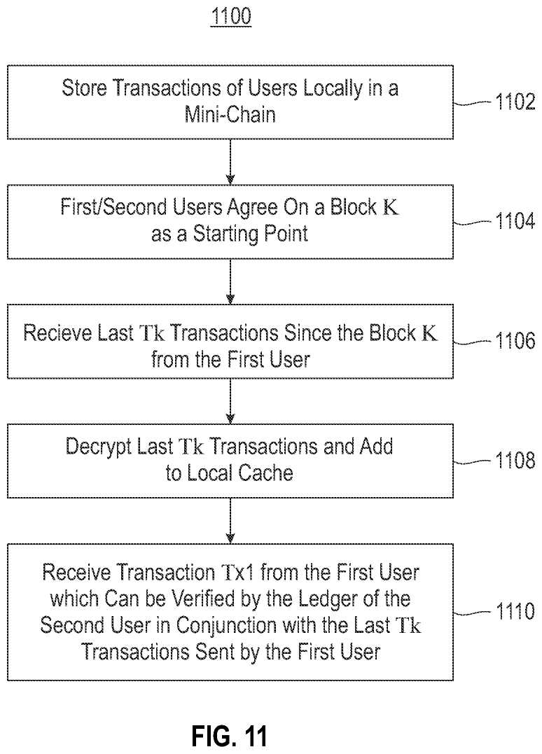

A summary of the above-described techniques for securing an off-line transaction using broadcast encryption is now provided by way of reference to methodology 1000 and methodology 1100 of FIG. 10 and FIG. 11, respectively. Specifically, methodology 1000 of FIG. 10 summarizes the steps performed by the user in the network that creates the transaction (e.g., User A in the above example) in accordance with the present techniques. Methodology 1100 of FIG. 11 summarizes the steps performed by the other users in the network (e.g., including User D in the above example) in accordance with the present techniques.

Referring first to methodology 1000 of FIG. 10, in step 1002 the transactions of each of the users in the network are stored locally on devices of the users in a mini-chain. As described above, this permits the devices to agree on a ledger height for verifying the off-line transactions. Thus, when transacting off-line, in step 1004 a first user (e.g., User A) and a second user (e.g., User D) will first agree upon a given block K as a starting point from which the first user (User A) will transmit all of her transactions to the second user (User D). As described above, this starting point block is based on a height M of a ledger of the first user (User A) and a height K of a ledger of the second user (User D). In the present example, the height M of the ledger of the first user (User A) is greater than the height of the ledger of the second user (User D). In that case, the first user (User A) and the second user (User D) will agree on block K as the starting point to ensure full transparency.

In step 1006, the first user (User A) encrypts all of the transactions in her digital wallet using reverse broadcast encryption such that the first user (User A) can encrypt but cannot decrypt the transactions, and other users including the second user (User D) can decrypt but cannot encrypt the transactions. In this manner, the first user (User A) is required to reveal all or none of the transactions in her digital wallet since the first user (User A) does not know which of the transactions is which.

In step 1008, the first user (User A) sends her last Tk transactions since the block K to the second user (User D). As highlighted above, these last Tk transactions are encrypted, but cannot be decrypted, by the first user (User A). The second user (User D) will now have a history of the transactions from prior to the agreed upon starting point block K in his ledger, as well as the first user's (User A's) last Tk transactions. Thus, when in step 1010 the first user (User A) sends a subsequent transaction Tx1 to the second user (User D), that transaction Tx1 can be verified by the second user (User D) using his ledger in conjunction with the last Tk transactions sent by the first user (User A). Thus, occurrences of actions such as double spending can be avoided.

From the other end of the transaction, methodology 1100 of FIG. 11 describes the steps performed by the other users in the network (e.g., including User D). In the same manner as above, in step 1102 the transactions of each of the users in the network are stored locally on devices of the users in a mini-chain, which permits the devices to agree on a ledger height for verifying the off-line transactions. See step 1104. In this example, the same block K as above will be used as the agreed upon starting point. As described above, this starting point block is based on a height M of the ledger of the first user (User A) and a height K of the ledger of the second user (User D), wherein the height M of the ledger of the first user (User A) is greater than the height of the ledger of the second user (User D).

In step 1106, the second user (User D) receives the last Tk transactions since the block K from the first user (User A). As provided above, the first user (User A) employs reverse broadcast encryption to encrypt all of the transactions in her digital wallet, such that the first user (User A) can encrypt but cannot decrypt the transactions, and other users including the second user (User D) can decrypt but cannot encrypt the transactions. In this manner, the first user (User A) is required to reveal all or none of the transactions in her digital wallet since the first user (User A) does not know which of the transactions is which. Thus, these last Tk transactions encrypted by the first user (User A) can be decrypted, but cannot be encrypted, by the second user (User D). Accordingly, in step 1108, the second user (User D) decrypts these last Tk transactions and adds them to a local cache.

The second user (User D) now has a history of the transactions from prior to the agreed upon starting point block K in his ledger, as well as the first user's (User A's) last Tk transactions. Thus, when in step 1110, the second user (User D) receives a subsequent transaction Tx1 from the first user (User A), the second user (User D) can verify the transaction Tx1 using his ledger in conjunction with the last Tk transactions from the first user (User A) he has stored in the local cache.

As will be described below, one or more elements of the present techniques can optionally be provided as a service in a cloud environment. For instance, when connected to the network, the function of one or more of the user devices can be performed on a dedicated cloud server to take advantage of high-powered CPUs and GPUs, after which the result is sent back to the local device.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Turning now to FIG. 12, a block diagram is shown of an apparatus 1200 for implementing one or more of the methodologies presented herein. By way of example only, apparatus 1200 can serve as a user device (e.g., that embodies system 300), and be configured to implement one or more of the steps of methodology 100 of FIG. 1, one or more of the steps of methodology 400 of FIG. 4, one or more of the steps of methodology 500 of FIG. 5, one or more of the steps of methodology 800 of FIG. 8, one or more of the steps of methodology 900 of FIG. 9, one or more of the steps of methodology 1000 of FIG. 10 and/or one or more of the steps of methodology 1100 of FIG. 11.

Apparatus 1200 includes a computer system 1210 and removable media 1250. Computer system 1210 includes a processor device 1220, a network interface 1225, a memory 1230, a media interface 1235 and an optional display 1240. Network interface 1225 allows computer system 1210 to connect to a network, while media interface 1235 allows computer system 1210 to interact with media, such as a hard drive or removable media 1250.

Processor device 1220 can be configured to implement the methods, steps, and functions disclosed herein. The memory 1230 could be distributed or local and the processor device 1220 could be distributed or singular. The memory 1230 could be implemented as an electrical, magnetic or optical memory, or any combination of these or other types of storage devices. Moreover, the term “memory” should be construed broadly enough to encompass any information able to be read from, or written to, an address in the addressable space accessed by processor device 1220. With this definition, information on a network, accessible through network interface 1225, is still within memory 1230 because the processor device 1220 can retrieve the information from the network. It should be noted that each distributed processor that makes up processor device 1220 generally contains its own addressable memory space. It should also be noted that some or all of computer system 1210 can be incorporated into an application-specific or general-use integrated circuit.

Optional display 1240 is any type of display suitable for interacting with a human user of apparatus 1200. Generally, display 1240 is a computer monitor or other similar display.

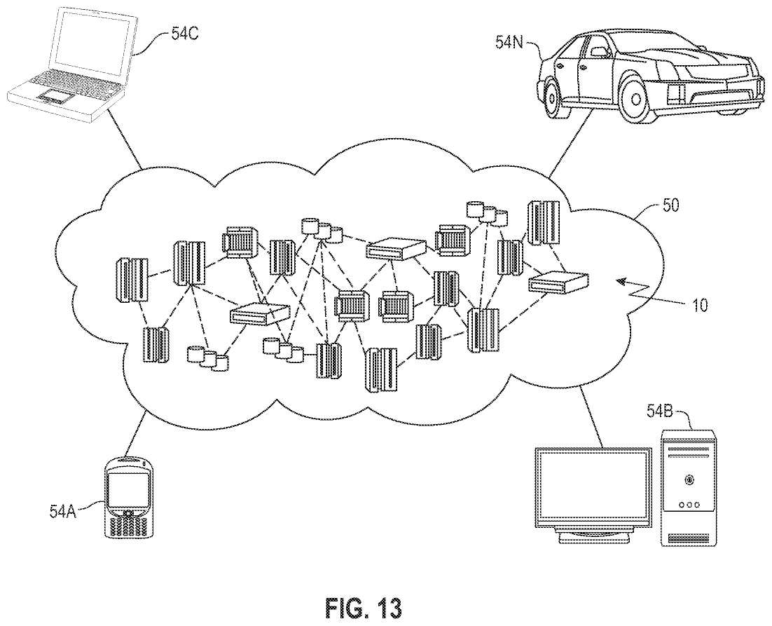

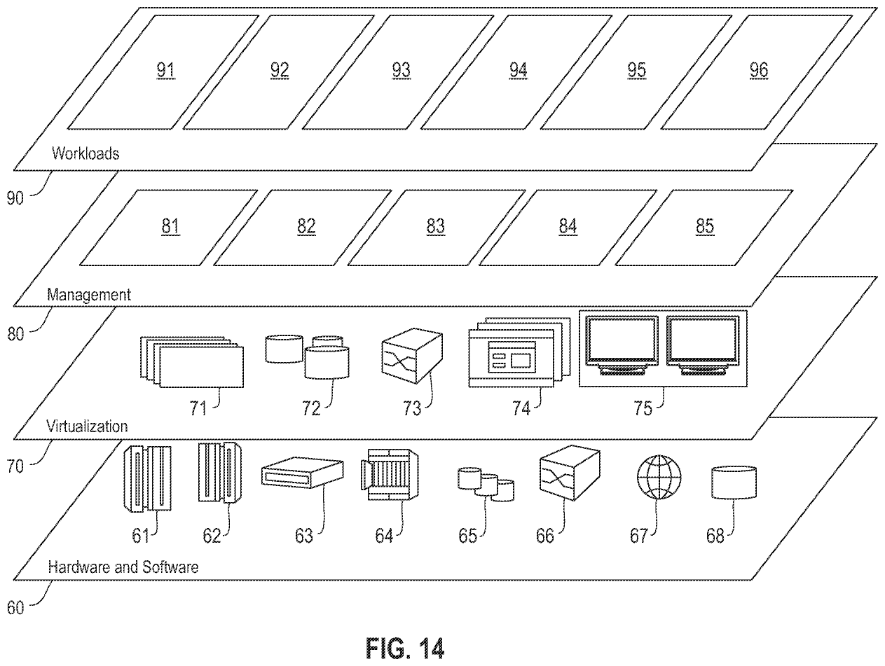

Referring to FIG. 13 and FIG. 14, it is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 13, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 13 are intended to be illustrative only and that computing nodes 10 and cloud computing environment 50 can communicate with any type of computerized device over any type of network and/or network addressable connection (e.g., using a web browser).

Referring now to FIG. 14, a set of functional abstraction layers provided by cloud computing environment 50 (FIG. 13) is shown. It should be understood in advance that the components, layers, and functions shown in FIG. 14 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and distributed adversarial training 96.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A method for securing transactions, the method comprising:
encrypting the transactions in a digital wallet of a user in a digital network in a manner whereby the user can encrypt but cannot decrypt the transactions, and other users in the digital network can decrypt but cannot encrypt the transactions, thereby requiring the user to reveal all or none of the transactions in the digital wallet of the user since the user does not know which of the transactions is which,
wherein one or more of the transactions are conducted off-line without users having a connection to the digital network.

2. The method of claim 1, further comprising:
storing the transactions of each of the users locally on devices of the users in a mini-chain in order to permit the devices to agree off-line on a ledger height for verifying the transactions.

3. The method of claim 2, wherein linking in the mini-chain is done via Merkle Chaining.

4. The method of claim 1, wherein the digital network comprises a blockchain network.

5. The method of claim 1, wherein the encrypting is performed using reverse broadcast encryption based on a binary tree with nodes of the binary tree comprising the users, and wherein the method further comprises:
always self-revoking in order to prevent the users from decrypting their own transactions; and
revoking one or more of the other users who no longer need or warrant access to the digital network.

6. The method of claim 1, wherein the one or more transactions that are conducted off-line are carried out using mobile devices of the users via proximity-based connectivity.

7. The method of claim 6, wherein the transactions comprise pay-for-charge transactions wherein one of the mobile devices is used to charge another one of the mobile devices.

8. The method of claim 1, further comprising:
transmitting the transactions that have been encrypted to the other users in the digital network.

9. The method of claim 1, wherein a first user and a second user are transacting off-line, and wherein the method further comprises:
agreeing upon a block K as a starting point based on a height M of a ledger of the first user and a height K of a ledger of the second user, wherein the height M is greater than the height K; and
sending, by the first user, last Tk transactions since the block K to the second user, wherein the last Tk transactions are encrypted, but cannot be decrypted, by the first user.

10. The method of claim 9, further comprising:
sending, by the first user, a transaction Tx1 to the second user, wherein the transaction Tx1 can be verified by the second user using the ledger of the second user in conjunction with the last Tk transactions sent by the first user.

11. A method for securing transactions, the method comprising:
receiving all of the transactions from a digital wallet of a user in a digital network by other users in the digital network, wherein the transactions are encrypted in a manner whereby the user can encrypt but cannot decrypt the transactions, and the other users in the digital network can decrypt but cannot encrypt the transactions, thereby requiring the user to reveal all or none of the transactions in the digital wallet of the user since the user does not know which of the transactions is which; and
decrypting, by the other users, the transactions,
wherein one or more of the transactions are conducted off-line without users having a connection to the digital network.

12. The method of claim 11, further comprising:
storing the transactions of each of the users locally on devices of the users in a mini-chain in order to permit the devices to agree off-line on a ledger height for verifying the transactions.

13. The method of claim 12, wherein linking in the mini-chain is done via Merkle Chaining.

14. The method of claim 11, wherein the decrypting is performed using reverse broadcast encryption based on a binary tree with nodes of the binary tree comprising the users, and wherein the method further comprises:
always self-revoking in order to prevent the users from decrypting their own transactions; and
revoking one or more of the other users who no longer need or warrant access to the digital network.

15. The method of claim 11, wherein a first user and a second user are transacting off-line, and wherein the method further comprises:
agreeing upon a block K as a starting point based on a height M of a ledger of the first user and a height K of a ledger of the second user, wherein the height M is greater than the height K;
receiving, by the second user, last Tk transactions since the block K from the first user, wherein the last Tk transactions can be decrypted, but cannot be encrypted, by the second user; and
decrypting, by the second user, the last Tk transactions and adding the last Tk transactions to a local cache.

16. The method of claim 15, further comprising:
receiving, by the second user, a transaction Tx1 from the first user; and
verifying the transaction Tx1 using the ledger of the second user in conjunction with the last Tk transactions in the local cache.

17. The method of claim 16, further comprising:
broadcasting, by the second user, transactions of the second user and the last Tk transactions of the first user to a main ledger when connectivity to the digital network is available.

18. A non-transitory computer program product for securing transactions, the computer program product comprising a computer readable storage medium having program instructions embodied therewith, the program instructions executable by a computer to cause the computer to:
encrypt the transactions in a digital wallet of a user in a digital network in a manner whereby the user can encrypt but cannot decrypt the transactions, and other users in the digital network can decrypt but cannot encrypt the transactions, thereby requiring the user to reveal all or none of the transactions in the digital wallet of the user since the user does not know which of the transactions is which,
wherein one or more of the transactions are conducted off-line without users having a connection to the digital network.

19. The non-transitory computer program product of claim 18, wherein the program instructions further cause the computer to:
store the transactions of each of the users locally on devices of the users in a mini-chain in order to permit the devices to agree off-line on a ledger height for verifying the transactions.

20. The non-transitory computer program product of claim 18, wherein the program instructions further cause the computer to:
agree upon a block K as a starting point based on a height M of a ledger of the first user and a height K of a ledger of the second user, wherein the height M is greater than the height K; and
send, by the first user, last Tk transactions since the block K to the second user, wherein the last Tk transactions are encrypted, but cannot be decrypted, by the first user.
